(19) United States
(12) Patent Application Publication
(10) Pub. No.: US 2007/0022623 A1
(43) Pub. Date: Feb. 1, 2007

(54) LASER SURFACE DRYING

(75) Inventor: Lu Yongfeng, Lincoln, NE (US)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: BOARD OF REGENTS OF UNIVERSITY OF NEBRASKA, Lincoln, NE (US)

(21) Appl. No.: 11/461,297

(22) Filed: Jul. 31, 2006

Related U.S. Application Data
(60) Provisional application No. 60/703,603, filed on Jul. 29, 2005.

(51) Int. Cl. F26B 3/34; F26B 3/00

(52) U.S. Cl. 34/245; 34/443

(57) ABSTRACT

The description provided herein relates to using an excimer laser to dry the surface of a semiconductor wafer. The excimer laser is configured to produce a laser beam. The fluence of the laser beam can be varied by a power attenuator. The number of pulses delivered to the surface is controlled by a shutter, which can block the laser beam or allow it to pass. The laser beam is directed onto the surface through a series of mirrors. A measurement device monitors the liquids on the wafer to determine whether the liquid has been evaporated.

### CROSS-REFERENCE TO RELATED APPLICATIONS

This application claims the benefit of U.S. Provisional Application No. 60/703,603 filed Jul. 29, 2006 under the same title.

### BACKGROUND

The manufacture of modem electronic circuits begins with a semiconductor material (e.g., silicon). Because semiconductor materials do not conduct electricity well, the material is usually doped with a secondary material or impurity (e.g., boron) to create tiny areas that function as an electrical conductor. An insulator layer may also be formed on the semiconductor materials through the oxidation of silicon. To create an electronic circuit, an ingot of the semiconductor material is first sliced into thin wafers. The wafers are then sent through a series of processing steps, during which patterns of chemicals are placed on the wafers, creating the aforementioned transistors, conductors, and insulators.

Multiple independent electrical components can be patterned on a single wafer. The patterned wafer is typically diced into dies—or more informally, chips. Dicing enables a manufacturer to discard only the dies that contain flaws, rather than the whole wafer. In general, this process is quantified as the yield of a process, which is defined as the percentage of operational dies from the total number of dies on the wafer. Operational dies (i.e., the ones that do not contain flaws) can be connected to the input/output pins of a package using a process called bonding. A package refers to material added to an operational die to allow it to be handled without damage.

Many sequential processing steps are performed to create an operational die. Typically, photo-sensitive resistance (“photoresist”) patterns are first masked in minuscule detail (e.g., micrometer, nanometer, etc.) onto a wafer's surface. The wafer is then exposed to short-wavelength ultraviolet light. Next, the unexposed areas are etched away and cleaned. Hot chemical vapors are then deposited onto desired zones of the wafer and baked in high heat so the vapors can permeate into the desired zones. In traditional wafer fabrication, the aforementioned processes are often repeated hundreds of times, depending on the complexity of the desired circuits and connections.

Surface drying is a critical process in wafer fabrication and other technology industries. Surface drying is typically used to remove watermarks on the wafer's surface as watermarks that decrease the number of operational dies created from a wafer. Traditionally, watermarks are removed by drying a wafer's surfaces in a number of ways, including, but not limited to, spin drying, isopropyl alcohol (“IPA”) vapor drying, or Marangoni drying. Currently, most wafer foundries use IPA to dry a wafer's surface. Typically, a wet wafer is exposed to the hot vapor of IPA to displace water from the wafer's surface. The IPA is then evaporated by cooling the wafer's surface. Similarly, IPA also used in drying processes for flat panel displays (e.g., plasma displays, liquid crystal displays, etc.) and hard disks.

Using IPA to dry wafer surfaces, flat panels, and hard disks creates a whole host of problems. For instance, IPA drying has a number of safety, health, and environmental concerns. More specifically, large amounts of IPA are consumed and released into the environment, which poses serious environmental concern. IPA is also hazardous to the human body, creating a serious health concern for the operators in wafer foundries. Additionally, IPA is extremely flammable, thus creating a high risk of fire inside of today's clean rooms. Therefore, it would be advantageous to remove watermarks from semiconductor wafers while avoiding the pitfalls associated with IPA and other surface drying techniques.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The description provided herein generally relates to using a laser to dry the surface of a semiconductor wafer. The excimer laser is configured to produce a laser beam that is directed to a liquid layer on the wafer. The fluence (power density) of the laser beam can be varied by a power attenuator. The number of pulses delivered to the surface is controlled by a shutter, which can block the laser beam or allow it to pass. In one embodiment, the power attenuator and shutter are controlled by various electronics and a computing device. The laser beam may be directed onto the surface through a series of mirrors. A measurement device monitors the liquids on the wafer to determine whether the liquid has been completely evaporated.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary excimer laser for use in implementing an embodiment of the present invention;

FIG. 2A is a block diagram of a laser system for use in drying the surface of a semiconductor wafer, according to an embodiment of the present invention;

FIG. 2B is a block diagram of a laser system for use in drying the surface of a semiconductor wafer, according to an embodiment of the present invention; and

FIG. 3 is a flow chart of a process for drying the surface of a semiconductor wafer with a laser, according to an embodiment of the present invention.

### DETAILED DESCRIPTION

The subject matter described herein is presented with specificity to meet statutory requirements. However, the description herein is not intended to limit the scope of this patent. Rather, it is contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

As previously mentioned, numerous problems stem from using IPA to dry the surfaces of semiconductor wafers, panel displays, and hard disks. In general, the present invention relates to irradiating the surface of a semiconductor wafer with a laser to evaporate water or other liquids. As described herein, a semiconductor wafer is a thin slice of semiconducting material upon which individual dies, or electronic chips, are constructed by doping—for example, diffusion, ion implantation, etching—with materials containing donor impurity atoms. Examples of electronic circuits that may be imprinted on a silicon wafer include, without limitation, microcontrollers, microprocessors, transistors, integrated circuits, etc.

While semiconductor wafers might be described herein as silicon wafers, embodiments should not be limited to silicon. Rather, wafers of materials other than silicon may also be considered semiconductor wafers. Examples include, without limitation, germanium, gallium arsenide, and other such materials.

As those skilled in the art will appreciate, numerous processes exist for fabricating semiconductor wafers. In general, most are initiated by slicing an ingot of silicon into wafers. Desired dies can then be fabricated onto the sliced wafers using various well-known methods. In general, most fabrication methods consist of a series of steps to deposit special material layers on silicon wafers in precise amounts and patterns. Typically, the steps fall into four categories: deposition, removal, patterning, and modification of electrical properties.

The deposition step incorporates any process that grows, coats, or otherwise transfers a material onto the wafer. One of skill in the art will appreciate the use of traditional deposition technologies, such as physical vapor deposition (“PVD”), chemical vapor deposition (“CVD”), electrochemical deposition (“ECD”), molecular beam epitaxy (“MBE”), and atomic layer deposition (“ALD”) among others.

The removal steps include steps to remove material from the wafer either in bulk or selective form and consist primarily of etch processes, both wet etching and dry etching, such as reactive ion etch (“RIE”). One of ordinary skill in the art will further appreciate that chemical-mechanical planarization (“CMP”) may also be used as a removal process between levels.

The patterning steps include the series of processes that shape or alter the existing shape of the deposited materials and is generally referred to as lithography. In conventional lithography, the silicon wafer is coated with a chemical called a “photoresist.” A photoresist may be any light-sensitive material used to form a patterned coating on a wafer's surface. Those of skill in the art will understand that numerous materials may be used as a either a positive or negative resist. A resist is a thin layer of material—typically a viscous solution—used to transfer a circuit pattern to the semiconductor substrate which it is deposited upon. Furthermore, the photoresist may be exposed by a stepper. A stepper is a machine that focuses, aligns, and moves a mask, thus exposing select portions of the wafer to short wavelength light. In one embodiment, the unexposed regions are washed away by a developer solution. Alternatively, IPA may be applied to a wafer to evaporate water. As previously mentioned, IPA has a number of drawbacks due to its flammability and danger to the human body. After etching or other processing, the remaining photoresist may be removed by plasma ashing.

The modification step includes modifying electrical properties consisting of doping sources and drains originally by diffusion furnaces and later by ion implantation. These doping processes may be followed by furnace anneal or, in advanced devices, by rapid thermal anneal (“RTA”), which serves to activate implanted dopants.

The following example describes the fabrication process for a simple Complementary-symmetry Metal-Oxide Semiconductor (“CMOS”) integrated circuit on a silicon wafer. Initially, a p-type epitaxial layer is grown on the silicon wafer through chemical vapor deposition. Next, a nitride layer is deposited over the epi-layer, leaving behind exposed areas on the epi-layer. The exposed areas are then masked again in specific patterns before being subjected to diffusion or ion implantation to receive dopants (such as boron or phosphorus) forming n-wells. Silicon diodes are then grown to form field oxides that isolate the n-wells from other parts of the circuit. Another masking/oxidation cycle then follows to grow gate oxide layers over the n-wells intended for p-channel metal oxide semiconductor (“MOS”) transistors later on. Another mask and diffusion/implant cycle may then follow to adjust threshold voltages on other parts of the epi, intended for n-channel transistors later on. Next, a polysilicon layer is deposited over the silicon wafer followed by a masking/etching cycle to remove unwanted polysilicon areas and define polysilicon gates over the gate oxide of the p-channel transistors. At the same time, openings for the source and drain drive-ins are made on the n-wells by etching away oxide at the right locations. Next, another round of mask/implant cycle follows, this time driving the dopants into new openings of the n-wells, forming the p-type sources and drains. Next, a mask/implant cycle follows to form the n-type sources and drains of the n-channel transistors in the p-type epi. The wafer is then covered with phospho-silica glass, which is then subjected to reactive ion etching in specific patterns to expose the contact areas for metallization. Aluminum is then be sputtered onto the wafer, after which it is subjected to reactive ion etching to create connections between the various components of the circuit. The wafer is then covered with glassivation as its top protective layer, after which a mask/etch process is used to remove the glass over bond pads. The above example is merely provided for illustrative purposes and should not be construed to limit embodiments to any particular fabrication process or step.

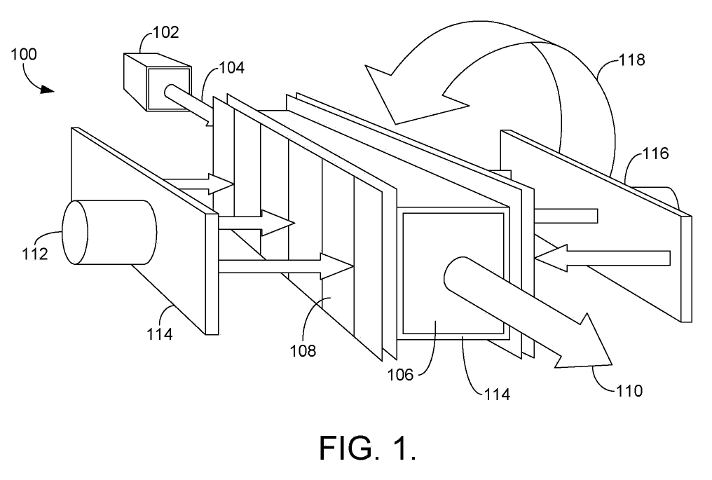

FIG. 1 is a block diagram of an exemplary laser for use in implementing an embodiment of the present invention. The laser in FIG. 1 is described herein as a KrF excimer laser for explanatory purposes only. Embodiments should not be limited, however, to KrF lasers. Rather, FIG. 1 also contemplates a myriad of excimer lasers created from various operation gases. It should be understood by one of ordinary skill in the art that the apparatus illustrated in FIG. 1 may also be used to produce a laser using argon fluoride (“ArF”), krypton chloride (“KrCl”), xenon chloride (“XeCl”), or other such gas. Alternatively, embodiments may also utilize a solid-state laser, instead of an excimer laser.

As illustrated in the following formula, a KrF laser absorbs energy from a source and causes krypton gas to react with fluorine gas, producing krypton fluoride, which is an unstable compound.
2Kr_{(g)}+F_{2(g)}^{electron energy}→2KrF_{(g)}
When the supplied energy is stopped, the compound will decompose and the excess chemical energy stored in the compound will release in the form of strongly synchronized radiation, as described in the following formula:
2KrF_{(g)}→2Kr_{(g)}+F_{2(g)}+energy

The result is an excimer laser that radiates energy in an ultraviolet frequency of 248 nm. Other gases contemplated by FIG. 1 (e.g., ArF, KrCl, XeCl, etc.) will radiate energy in different ultraviolet frequencies, as illustrated by the following table:

| EXCIMER | WAVELENGTH |
|---|---|
| ArF | 193 nm |
| KrCl | 222 nm |
| XeCl | 308 nm |
| XeBr | 282 nm |
| XeF | 351 nm |
| F₂ | 157 nm |

In one embodiment, a KrF laser, generally referenced as numeral 100 in FIG. 1, comprises a laser emitter 102 emitting an input laser beam 104 into a laser cell 106 filled with krypton and fluorine gases. More specifically, the input laser beam 102 propagates through a foil support 108 and deposits energy into the laser cell 106. Consequently, a complex set of ionizations and chemical reactions produce an excimer laser beam 110 that is directed out of the laser cell 106. More specifically, an excimer laser may be created by passing the laser beam 104 through a combination of an inert gas (e.g., argon, krypton, xenon) and a reactive gas (fluorine or chlorine). Consequently, a pseudo-molecule called a dimer is created, which can only exist in an energized state, thus giving give rise to laser light in the ultraviolet range. Additionally, a pulsed power system 112 is applied between a cathode 114 and an anode 116—thus allowing the laser beam 110 beam to efficiently and reliably be injected into the krypton and fluorine gases. A recirculator 118, in an embodiment, is used to cool and quiet the krypton and fluorine gases between shots of the input laser beam 104. FIG. 1 is merely provided for illustrative purposes and should not be construed to limit embodiments to any particular apparatus or component for creating an excimer laser.

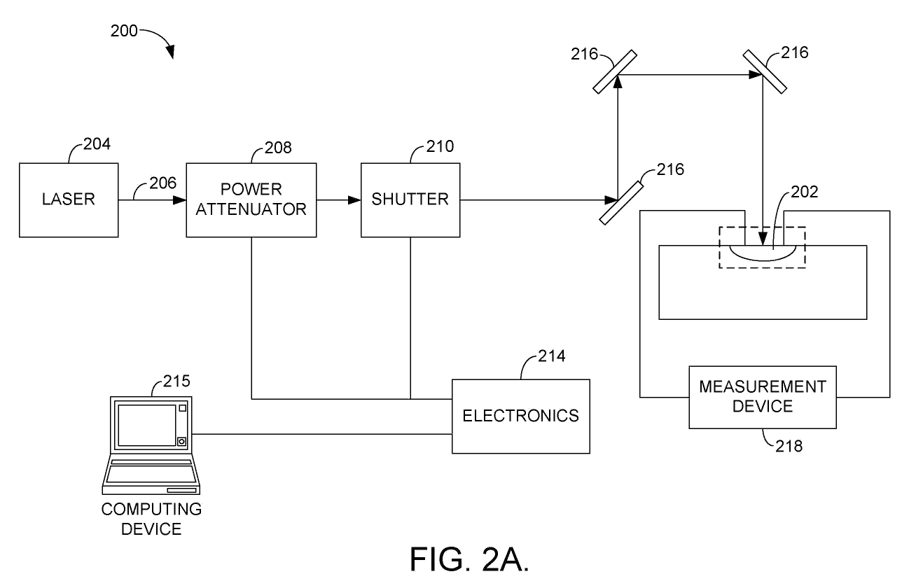

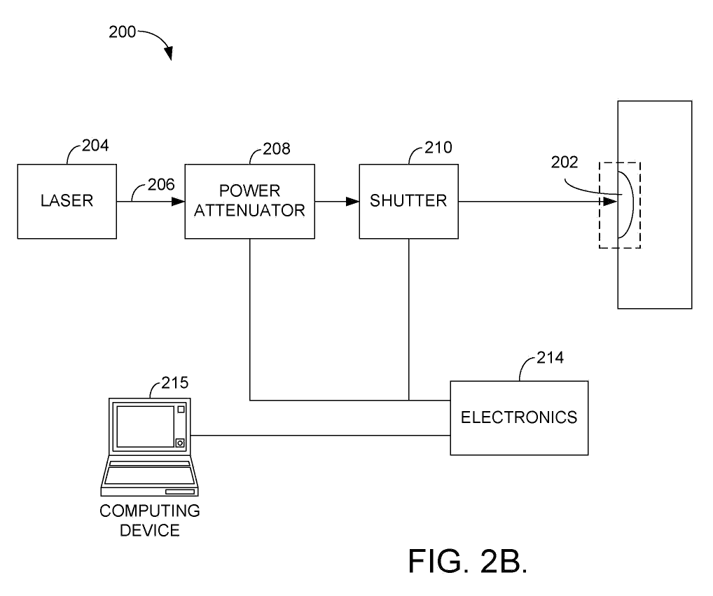

FIG. 2A is a block diagram of a laser system for use in drying the surface of a semiconductor wafer, according to an embodiment of the present invention. The system illustrated in FIG. 2A is generally referenced as numeral 200 and capable of evaporating water on a wafer surface 202. System 200 includes a laser 204, a power attenuator 208, a shutter 210, electronics 214, a computing device 215, mirrors 216, and a measurement device 218.

In one embodiment, the laser 204 includes the components described in reference to FIG. 1 and is configured to produce a laser beam 206 from KrF having a wavelength of 248 nm and a pulse of 20-30 ns. Alternatively, the laser 204 may be configured to produce the laser beam 206 from other gases, such as those referenced in the above table. In another embodiment, the laser 204 is a neodymium-doped yttrium aluminum garnet (“Nd:YAG”) laser. In some instances, such as when using ArF and F₂, lasers may not be advantageous because of decreased laser power, resulting in poor economic economy. Alternatively, such lasers may produce laser beams with shorter wavelengths, which requires placing the beams into nitrogen gas or a vacuum, resulting in additional cost and inflexible drying applications.

Additionally, the laser beam 206 may be directed to a beam homogenizer (not shown for clarity). In general, a beam homogenizer smoothes out irregularities in a laser beam profile to create a more uniform profile. For example, the beam homogenizer may comprise multifaceted mirrors to reflect the laser beam 206 in different angles—thus creating a square beam with uniform power. Embodiments should not be limited to any particular beam homogenizer since beam homogenizers are well known to those of ordinary skill in the art.

During a laser-drying process, the fluence of the laser beam 206 is vital. Fluence by definition is the energy per pulse divided by surface area. More precisely, fluence is the energy density of one single pulse of the laser beam 206 per size (i.e., energy/size). If the fluence of the laser beam 206 is too strong, the beam may damage the wafer surface 202.

In operation, the laser beam 206 is emitted from the laser 204. Next, the laser beam 206 is then directed to the power attenuator 208. The poer attenuator 208 is optionally configurable to adjust the fluence of the laser beam 206 using methods well known in the art. For example, the power attenuator 208 may include a diffractive grating to deflect the light beam 206 into several diffractive orders, some of which may be blocked by a diaphragm. In this scenario, the resultant diffraction efficiency and fluence of the laser beam 206 depend on the grating parameters in the power attenuator 208. By varying the grating, the fluence can effectively be changed. In another example, the power attenuator 208 may include a grating wheel mounted in an encapsulating housing with entrance and exit tubes. The housing and tubes effectively block parasitic diffractive orders and absorb laser radiation. Other well known methods of attenuating the laser beam 206 are known by those of skill in the art and may be employed within the power attenuator 208.

The laser beam 206 is directed from the power attenuator 208 to the shutter 210. The shutter 210 is configured to control the number of pulses delivered onto the wafer surface 202. In effect, the shutter 210 acts as an on/off switch, either terminating the laser beam 206 or allowing it to pass.

In one embodiment, the power attenuator 208 and the shutter 210 are both controlled by various electronic components (illustrated in FIG. 2 as electronics 214) well known to those skilled in the art. The electronics 214 are controlled by a user accessing a computing device 215, including, but not limited to, a personal computer, laptop, personal digital assistant (“PDA”), or other such electronic device.

In one embodiment, a configuration of mirrors 216 are positioned to direct the laser beam 206 onto the wafer surface 202. FIG. 2B shows an alternative embodiment that does not utilize mirrors to direct the laser beam 206; rather, such embodiments position the laser 204 such that the laser beam 206 is generated directly onto the wafer surface 202. Typically, the laser 204 is a heavy device, which makes it easier to redirect the laser beam 206 than to mount the laser 204 above the wafer surface 202.

Once the laser beam 206 irradiates the wafer surface 202, water that is resident on the wafer surface 202 is evaporated. Not only does the laser beam 206 evaporate the water molecules from the wafer surface, the laser beam 206 also breaks any bonding between the water molecules and the silicon of the wafer surface 202. Consequently, the water is completely evaporated from the wafer surface 202.

The measurement device 218 is configured, in one embodiment, to measure the film thickness of a liquid on the wafer surface 202. The measurement device 218 may include an ellipsometer to measure the refractive index and thickness of semi-transparent films. Typically, ellipsometers can measure water-film thicknesses down to 1 nm. Ellipsometers are well known to those of skill in the art and need not be discussed at length herein.

It may be desirable to measure the amount of water on the wafer surface 202 more precisely. Therefore, the measurement device 218 may also include, in an alternative embodiment, a Fourier transform infrared (“FTIR”) spectrometer. An FTIR spectrometer is generally more sensitive than an ellipsometer because the FTIR spectrometer measures vibrations of functional groups and highly polar bonds. FTIR spectrometers record the interaction of infrared radiation with experimental samples, measuring the frequencies at which the sample absorbs the radiation and the intensities of the absorption. Determining such frequencies identifies the samples'chemical makeup, because chemical functional groups absorb light at specific frequencies. FTIR spectrometers are well known to those of skill in the art.

The measurement device 218 may also include an X-ray photoelectronic spectroscopy (“XPS”) to investigate chemical composition and bonding energies. In one embodiment, the XPS determines the composition of silicon as well as the content of Si, SiO, and SiO₂ on the wafer surface 202. XPSs are well known to those of skill in the art.

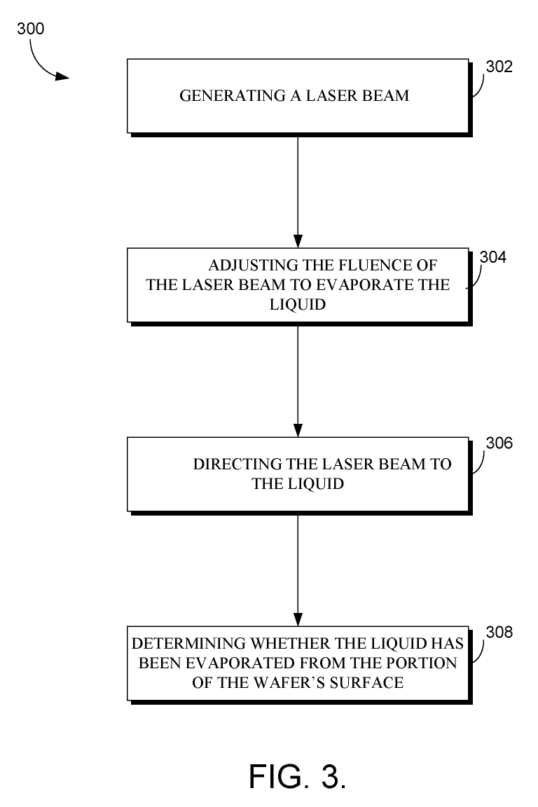

FIG. 3 is a flow chart of a process for drying the surface of a semiconductor wafer with a laser according to an embodiment of the present invention. Initially, a laser beam is generated, as indicated at 302. In one embodiment, the laser beam is generated at 302 by an excimer laser. The laser beam is then adjusted to the appropriate fluence for evaporating a liquid on a semiconductor wafer, indicated at 304. In one embodiment, the wafer is a silicon wafer and the liquid is water. Other semiconductor material and liquid combinations are also possible. The laser beam is directed to the liquid, indicated at 306, to irradiate and evaporate the liquid from the semiconductor wafer. After the beam has irradiated the liquid, it is then determined whether the liquid has been evaporated, indicated at 308.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

The invention claimed is:

1. A system for drying a portion of a wafer of semiconducting material, the portion of the wafer having a liquid on its surface, the liquid having a film thickness, the system comprising:
a laser configured to produce a laser beam to irradiate a liquid on the portion of the wafer, wherein the laser beam is directed to the liquid on the portion of the wafer;
an attenuator to vary the fluence of the homogenous laser beam based to evaporate the liquid; and
a measurement device to monitor the film thickness of the liquid.

2. The system of claim 1, further comprising a shutter configured to block the laser beam.

3. The system of claim 1, wherein the semiconductor material is silicon and the liquid is water.

4. The system of claim 1, wherein photons from the laser beam photochemically break the chemical bonds between the liquid and the semiconducting material.

5. The system of claim 1, wherein the measurement device comprises an ellipsometer.

6. The system of claim 1, wherein the measurement device comprises a Fourier transform infrared spectrometer.

7. The system of claim 1, further comprising one or more mirrors to reflect the laser beam onto the portion of the wafer.

8. The system of claim 1, wherein the laser beam has a wavelength of 248 nanometers and a pulse duration between 20-30 nanoseconds.

9. The system of claim 1, wherein the laser beam is a neodymium-doped yttrium aluminum garnet (“Nd:YAG”) laser beam.

10. The system of claim 1, wherein the laser beam is a solid-state laser beam.

11. The system of claim 1, wherein the laser beam is an excimer laser beam.

12. The system of claim 11 wherein the excimer laser beam is one of a krypton-luoride (KrF), xenon-chloride (XeCl), argon-fluoride (ArF), krypton-chloride (KrCl), xenon-bromide (XeBr), xenon-fluoride (XeFl), or fluoride (F₂) laser beam.

13. The system of claim 1, further comprising a power meter to receive a portion of the homogenized laser beam and determine the fluence of the laser beam.

14. The system of claim 1, further comprising an air blower to provide airflow across the portion of the wafer and prevent reaccumulation of the liquid on the portion of the wafer.

15. A method for evaporating a liquid on a portion of a wafer of semiconducting material, comprising:
generating a laser beam;
directing the laser beam to the portion of the wafer; and
determining whether the liquid has been vaporized by the laser beam.

16. The method of claim 15, wherein the laser beam is generated by an excimer laser.

17. The method of claim 16, wherein the laser beam is a Krypton-Fluoride (KrF) laser beam.

18. The method of claim 16, wherein determining whether the liquid has been vaporized by the laser further comprises measuring the refractive index and thickness of the film-thickness of the liquid.

19. The method of claim 16, wherein determining whether the liquid has been vaporized by the laser further comprises measuring vibrations of functional groups and highly polar bonds.

20. A method for evaporating a liquid on a portion of a wafer of semiconducting material, comprising:
generating a laser beam;
adjusting the fluence of the laser beam to evaporate the liquid;
directing the laser beam to the portion; and
determining whether the liquid has been vaporized by the homogenized laser beam.
